(19) United States
(12) Patent Application Publication
(10) Pub. No.: US 2012/0313500 A1
(43) Pub. Date: Dec. 13, 2012

(54) Lamp with reflector means and reflector element

(75) Inventors: Nicole Breidenassel, Bad Abbach (DE); Steffen Tegethoff, Pentling (DE)

(73) Assignee: OSRAM AG, Muenchen (DE)

(21) Appl. No.: 13/580,667

(22) PCT Filed: Mar. 7, 2011
(86) PCT No.: PCT/EP2011/053380

§ 371 Date: Aug. 23, 2012

(30) Foreign Application Priority Data
Mar. 22, 2010 (DE) 10 2010 003 123.2

(51) Int. Cl. F21V 14/00; F21V 7/00; F21V 29/00

(52) U.S. Cl. 313/46; 313/113; 362/341

(57) ABSTRACT

In various embodiments, a lamp may include at least one light source; and at least one reflector means for reflecting light that has been emitted by the at least one light source, it being possible for the at least one reflector means to have a radial asymmetric form about a longitudinal axis of the lamp.

The invention relates to a lamp which has at least one partially transparent bulb which extends over at least one light source of the lamp, and at least one reflector means arranged on the lamp. The invention further relates to a reflector element for subsequent fastening to a lamp.

Lamps having a virtually spherical light emission pattern, for example filament lamps, are frequently used in light fixtures or lampholders in which actual lamps with directional light emission patterns have to be used, for example light fixtures above mirrors, ceiling luminaires, bedside lamps, etc. These encourage a waste of energy and cause a less than optimum luminance level to be obtained at the actual site to be illuminated.

Filament lamps are known in which the front tips of their bulbs are coated in a reflective manner in order to suppress forwards light emission. This reflective area is constructed in the form of a spherical cap, so that an intersecting plane of a related spherical section is oriented vertically to a longitudinal axis of the filament lamp.

Furthermore, lamps are known in which reflector panels which are designed to direct the light are employed in the bulb. However, the alignment of such lamps is difficult, particularly if they are fitted with screw bases.

The object of the present invention is to provide an improved method for directing a luminous flux emitted by a lamp.

This object is achieved according to the features of the independent claims. Preferred embodiments can be inferred in particular from the dependent claims.

The object is achieved by a lamp having an at least partially transparent bulb which extends over at least one light source of the lamp, and having at least one reflector means for reflecting light which has been emitted by the at least one light source, it being possible for the at least one reflector means to have a radial asymmetric form about a longitudinal axis of the lamp.

Due to the radial asymmetric form of the at least one reflector means and consequently the achievable adjustment of the angular position with respect to the longitudinal axis of the lamp, a direction of light emission of the lamp can be adjusted to the desired direction of light emission of the light fixture and, in particular, light emission in areas in which for example the light is not utilized and is absorbed by the light fixture; in particular angular areas of the light fixture where said light is suppressed or even completely prevented. This is particularly useful since many light fixtures use such a laterally directed emission, for example many types of wall lights. A higher light intensity is also achieved in the area of the lamp, in particular of the bulb if present, not covered by the reflector means, or an identical light intensity can be maintained by a lower lamp power rating, which equates to an energy saving. The embodiment with the radial asymmetric form can also be advantageously used if the at least one reflector means is not rotatable about a longitudinal axis of the lamp, for example if a rotational position of the lamp (or of the base of the lamp with respect to a socket of the light fixture or a lamp adapter) can be defined with respect to a light fixture by the interaction between base and socket.

In one embodiment the at least one reflector means can be rotated about a longitudinal axis of the lamp.

In particular, after screwing the lamp into the socket (end position) the user can still rotate the reflector means itself in order to orient the latter so that the light emerges or is directed in the direction preferred by said user. This rotation or adjustment option is, in particular, advantageous in present-day screwed base systems (for example E27) or bayonet base systems (for example GU10) since, after being screwed in or plugged in, the lamp is more often than not positioned in the socket with a random, unwanted orientation.

In principle, the type of light source is not limited. Preferably, the at least one light source includes at least one light emitting diode. If there is a plurality of light emitting diodes, these can light up in identical colors or in different colors. One color can be monochromatic (for example red, green, blue etc.) or multichromatic (for example white). The light emitted by the at least one light emitting diode can also be an infrared light (IR LED) or an ultraviolet light (UV LED). A plurality of light emitting diodes can produce a mixed light; for example a white mixed light. The at least one light emitting diode can contain at least one wavelength-converting luminescent material (conversion LED). The at least one light emitting diode can be in the form of at least one individually packaged light emitting diode or in the form of at least one LED chip. A plurality of LED chips can be mounted on a common substrate (“submount”). The at least one light emitting diode can be equipped with at least one of its own and/or common optical systems for beam guidance, for example at least one Fresnel lens, collimator, et cetera. In general, instead of or in addition to inorganic light emitting diodes, for example based on InGaN or AlInGaP, organic LEDs (OLEDs, for example polymer OLEDs) can also be utilized. Diode lasers can also be used for example. Alternately, the at least one light source can have at least one diode laser for example.

The angular position of the at least one reflector means can thus be adjusted with respect to the lamp, in particular with respect to its base.

In a further embodiment the lamp is an LED retrofit replacement for an incandescent lamp.

In a development, the lamp has an at least partially transparent bulb which extends over the at least one light source of the lamp, it being possible for the at least one reflector means to be arranged on the bulb.

The bulb can be a diffuse (opal or frosted) or a transparent (clear) bulb. The bulb can consist of plastic, glass, ceramic or another transparent material.

The reflector means “arranged on the bulb” can be placed directly on the bulb or arranged near to the bulb. The reflector means can be arranged inside the bulb or outside the bulb. Light of the at least one light source that irradiates an area of the bulb covered by the reflector means is reflected by the reflector means. Here the light is reflected at the reflector means arranged inside the bulb before it reaches the bulb or is reflected at the reflector means arranged outside the bulb after it has passed through the bulb, it then being possible for the light to be reflected back into the bulb again.

The angular position of the at least one reflector means can therefore be adjusted with respect to the lamp, in particular with respect to its base.

In one embodiment the lamp is an LED retrofit replacement for an incandescent lamp.

It is particularly advantageous if the reflector means can be used in conjunction with a lamp, in particular an LED retrofit replacement for an incandescent lamp, which has a screw base. Typically, where a lamp is mounted in an associated socket, the rotational position of the lamp with respect to the socket (and therefore usually also with respect to a light fixture) cannot be determined in advance. The present lamp can compensate for this uncertainty in the rotational position and produce a defined direction of emission and also of the light fixture.

The at least one light emitting diode can, in particular, be directed forwards so that its optical axis is oriented parallel to a longitudinal axis of the lamp. Since a light emitting diode typically has an angle symmetric light emission with respect to its optical axis, a considerable portion of the light emitted by the light diode can be reflected by the at least one reflection means.

In a further embodiment, the lamp has a heatsink, the at least one light source being arranged at its front face to which the bulb is also connected. To conform approximately to the shape of a conventional filament lamp, the bulb can be designed, in particular, in the form of a spherical cap. The heatsink can have, in particular, an external contour essentially in the shape of a cylinder or frustum of a cone. At its outer face, the heatsink can have at least one cooling structure, for example cooling ribs or cooling fins.

In another embodiment, the at least one reflector means is configured in the form of a clip-on or latch-tight (snap-on) reflector element, which surrounds one part of the lamp, in particular the bulb, and is relatively rotatable about the longitudinal axis.

Consequently, retrofit filament lamps which initially have been manufactured without the reflector element and can also be used without the reflector element, can subsequently be simply and economically fitted with the reflector means. The emission characteristic can be adjusted on the lamp by simply rotating the snap-on element. For an angle symmetric adjustment, the rotation is made about the longitudinal axis of the lamp.

In an additional embodiment, the reflector means has a clamp or clips for rotatable locking between the heatsink and the bulb. This results in a reflecting body that is particularly simple to manufacture. In particular, the clamps can be simply and securely inserted into an external gap or recess commonly formed between the heatsink and the bulb. This recess provides guidance and locking for the snap-on element with respect to its position along the longitudinal axis.

In another embodiment, the at least one reflector means is configured as an at least one reflecting layer of the bulb. The reflecting layer can be placed on an inner face of the bulb and/or on an outer face of the bulb. This arrangement has the advantage that it is obtained without significant increase in volume or additional elements (which is particularly advantageous for retrofit lamps, which should maintain the shape factor of the lamps they are replacing) and is particularly durable. In particular, the bulb can be made rotatable so that after the user has screwed the lamp into the socket (end position) said user can still rotate the bulb itself in order to orient the reflecting layer so that the light emerges or is directed in the direction preferred by said user.

In a special development, the bulb can be rotated. In particular, the bulb can be supported in a rotatable fashion around the longitudinal axis of the lamp for adjustment of the angle or angular position of the reflector means. For example, the bulb can be mounted or supported in the heatsink in a rotatable fashion. The emission angle of the lamp can therefore be simply set without auxiliary means or elements. Alternately, the bulb can be fixed in a stationary manner to the heatsink and/or a driver housing and the heatsink and/or the driver housing can be rotated relative to a lamp base, in particular about a longitudinal axis of the lamp.

In a further embodiment, the bulb can in parts have a reflecting material. For example, the lamp can be filled with reflecting particles in certain areas.

Furthermore, in one embodiment, the at least one reflector means is configured and arranged as a type of cap at one side face of the bulb (that is to say not rotationally symmetrical to the longitudinal axis).

The at least one reflector means can therefore be concentrated in at least one angular area of the bulb and cover a larger surface than in at least one other area. In other words, the reflector means is not configured angle symmetric with respect to the longitudinal axis, so that the light of the lamp is no longer emitted in an angle symmetric manner.

The reflector means can in particular be configured to conform to the bulb essentially at the surfaces covered by the reflector means. Owing to its direct attachment to the bulb this applies to a reflecting layer. The clip-on reflector element can essentially lie flat against or be pressed onto one outer face of the bulb and/or be spaced at a small distance away from it. The inner face of the reflector element can be configured in particular in a similar way to the outer face of the bulb at least at the area covered by the reflector element.

The reflector can in particular be made reflecting at least at its surface (inner face) directed towards the bulb.

A spherical surface type of arrangement can mean in particular an arrangement which covers an area of the bulb in a reflecting manner (whether it be as a layer, integral area or reflector element), it being possible for at least one limit or edge of the area to be defined by at least one imaginary intersecting plane which passes through the bulb (‘spherical surface section’).

Moreover, in one embodiment, at least one spherical surface section lies essentially parallel to the longitudinal axis of the lamp. For example, such a reflector means can be configured in the form of an angular sector so that its edges with respect to the bulb are formed by two intersecting planes angularly displaced with respect to the longitudinal axis and intersecting planes coplanar to the longitudinal axis.

Alternately, such a reflector means can be defined by an intersecting plane which runs parallel at a distance from the longitudinal axis.

In another embodiment, the longitudinal axis of the lamp does not intersect the reflector means. Consequently, in the forward direction the lamp is covered and, accordingly, forward light emission is considerably reduced.

Alternately, the longitudinal axis of the lamp can intersect the reflector means, whereby, in particular, forward light emission can be correspondingly reduced and an angular area illuminated by the lamp can also be decreased.

An intersecting plane of the reflector means can also lie on the longitudinal axis, whereby, in particular, a half-space reflector, for example a half-space reflector cap in the case of a clip-on reflector element, can be produced.

The object is also achieved by a reflector element for subsequent fastening, in particular rotatable fastening to a lamp, it being possible for the reflector element to have in particular at least one clamp or clip for fixing the reflector element in a clamping, rotatable manner. In general, the reflector element can have any type of fixing element for subsequent fixing to the lamp, in particular in a rotatable manner.

In this case the fixing element, in particular the clamp, can be fixed to any area of the lamp. The fixing element can therefore be fixed to the bulb (in particular if this can at least partially encircle the bulb), be fixed between the bulb and the heatsink or housing, be fixed to the heatsink or housing (for example in an annular slot), in particular be fixed in the vicinity of the base and/or even to the socket.

In one development the reflector element can cover a bulb of the lamp in a partially reflecting manner.

In this way, retrofit filament lamps which initially have been manufactured without the reflector means and can also be used without the reflector means, can subsequently be fitted with the reflector area in a simple and economical manner. The emission characteristic can be adjusted on the lamp by simply rotating the snap-on element. For an angle symmetric adjustment, the rotation is preferably made about the longitudinal axis of the lamp. However, if the fixing element (and also the lamp) is not restricted to an application involving retrofit filament lamps, then this can also be used, for example, for bulb-less retrofit halogen lamps.

In the following figures the invention is described schematically in more detail with the aid of exemplary embodiments. In this case, for the sake of clarity, identical elements or those with identical operation, have identical reference numbers.

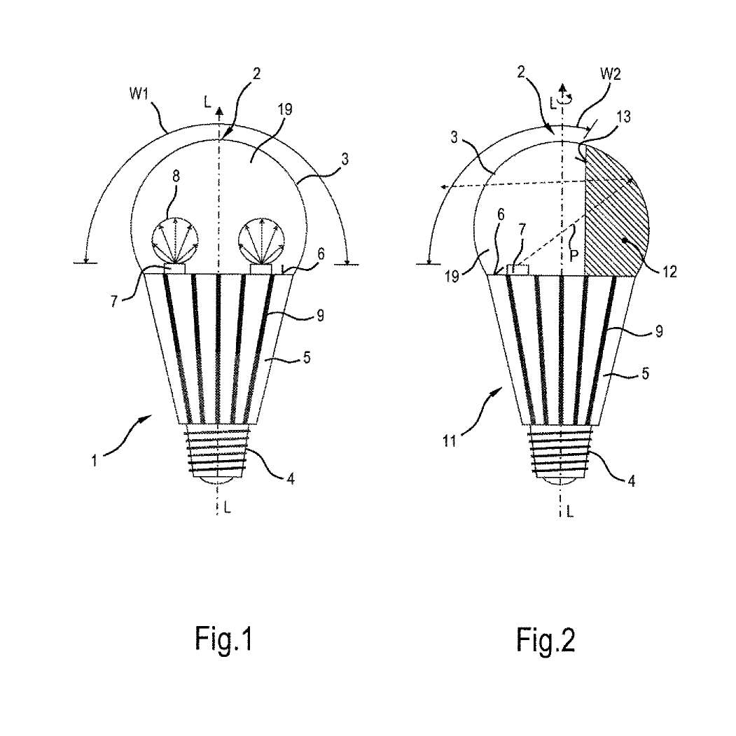

FIG. 1 shows a side view of an LED retrofit replacement for an incandescent lamp without a reflector means;

FIG. 2 shows a side view of an inventive LED retrofit replacement for an incandescent lamp according to a first exemplary embodiment with a reflector means;

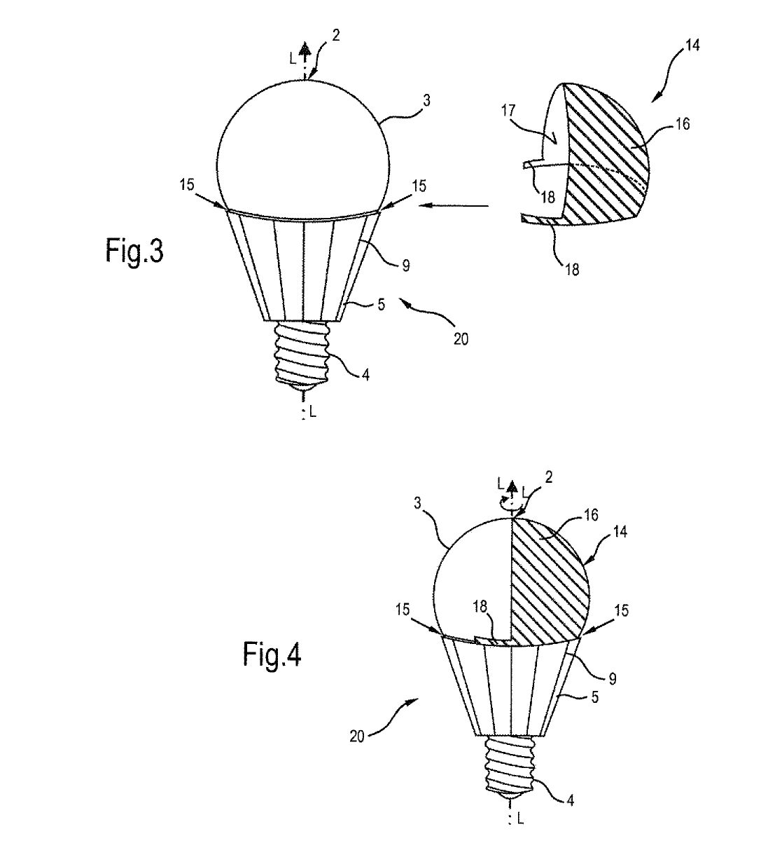

FIG. 3 shows a side view of a retrofit filament lamp according to a second exemplary embodiment and a reflector element that is attachable thereto;

FIG. 4 shows a side view of the retrofit filament lamp according to the second exemplary embodiment with the reflector element attached thereto;

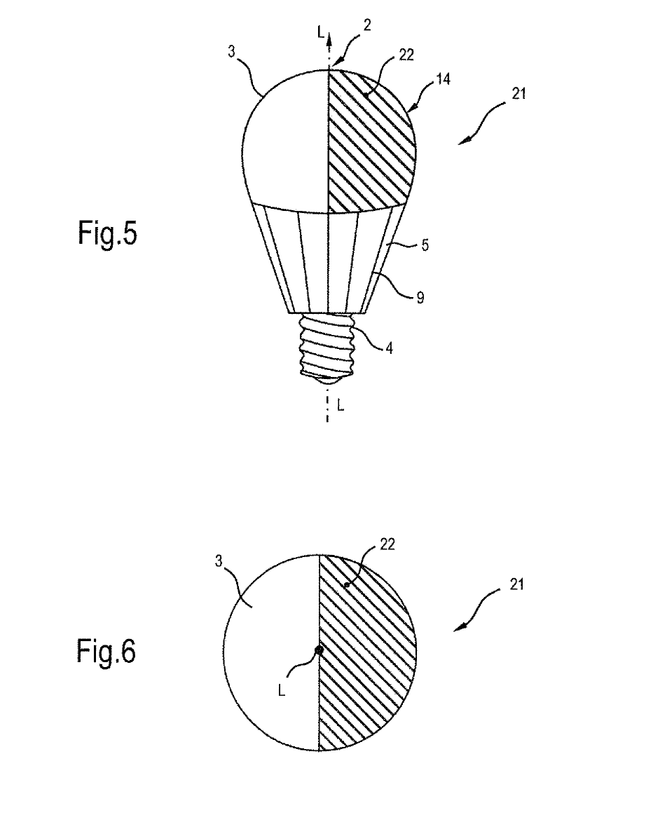

FIG. 5 shows a side view of an inventive LED retrofit replacement for an incandescent lamp according to a third exemplary embodiment;

FIG. 6 shows a plan view of the LED retrofit replacement for an incandescent lamp according to the third exemplary embodiment;

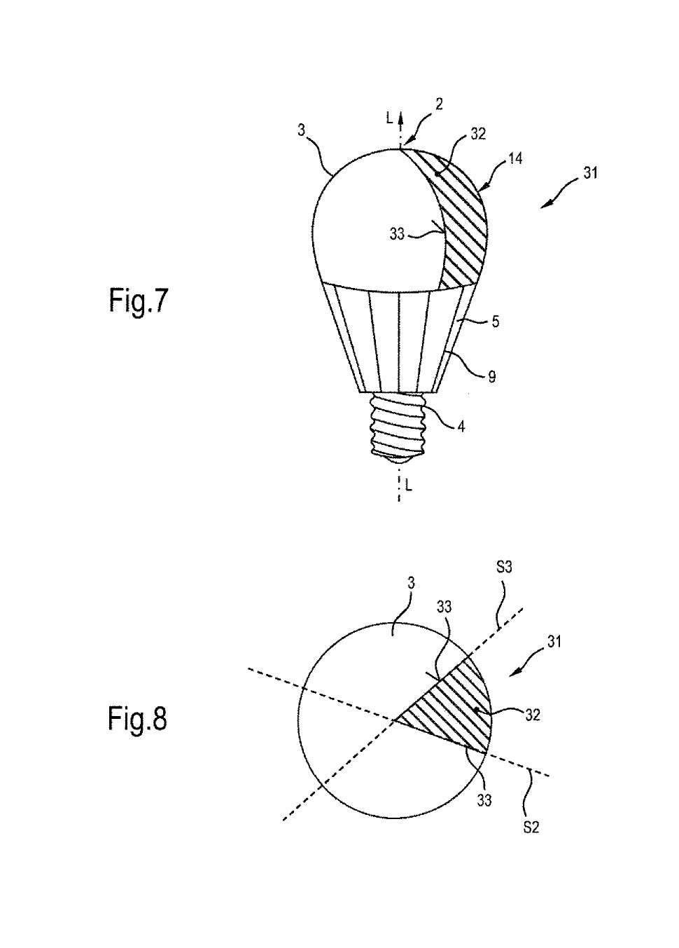

FIG. 7 shows a side view of an inventive LED retrofit replacement for an incandescent lamp according to a fourth exemplary embodiment; and

FIG. 8 shows a plan view of the LED retrofit replacement for an incandescent lamp according to the fourth exemplary embodiment.

FIG. 1 shows a side view of a lamp 1 in the form of an LED retrofit replacement for an incandescent lamp without a reflector means. The lamp 1 has a longitudinal axis L that with respect to the lamp 1 is essentially configured as rotation symmetric or angle symmetric, it being possible for the front end of the lamp 1 to be defined by a tip 2 of a transparent bulb 3 and a back or rear end of the lamp 1 is defined by a base 4, here in the form of an Edison screw base. The base 4 is connected to a heatsink 5 in which is located a driver cavity (not shown) to house at least one part of an electronic driver unit. The outer face of the heatsink 5 can have a cooling structure, for example surrounded by a plurality of cooling fins or ribs 9.

A plurality of light emitting diodes (LEDs) 7 is positioned, for example in the form of a ring, at one front face 6 of the heatsink 5. The light emitting diodes 7 roughly correspond to Lambertian sources whose intensity is greatest in the forward direction (so-called Top LED) as indicated by the respective circle 8. Consequently, the optical axis of the light emitting diodes 7, which also indicates the direction of the greatest radiation intensity, lies parallel to the longitudinal axis L. The light emitting diodes 7 are covered by the bulb 3. The bulb 3 is essentially constructed in the form of a spherical cap, it being possible for it to be permanently attached to the heatsink 5 by its open end or edge. The bulb 3 can be transparent or opaque and consist of plastic or glass, for example.

The light is emitted in the entire front half-space, as indicated by the angular area W1 and, depending on the construction, also partially in the rear half-space. The light emission of the lamp 1 is, in particular with respect to the longitudinal axis L angle symmetric, so that energy is wasted when the lamp 1 is built into a light fixture which does not require any lamp with such an emission characteristic.

FIG. 2 shows a side view of an inventive lamp 11 in the form of an LED retrofit replacement for an incandescent lamp according to a first exemplary embodiment similar to the lamp 1 in FIG. 1, it now being possible for the lamp 11 to be fitted with a reflector means 12. In this case the reflector means 12 exists in the form of a diffuse or mirror-type, reflecting coating, at least in the direction of an inner space 19 of the bulb 3. The reflector means 12 or the coating can be located at one inner face and/or at one outer face of the bulb 3. The reflector means 12 is constructed as a spherical cap or in the form of a solid section at one side face of the bulb 3. In this case, an imaginary line of intersection or spherical surface section 13, which defines the edge of the reflector means 12 at the bulb 3, lies coplanar and at a distance from the longitudinal axis L. Since the bulb 3 is essentially in the shape of a spherical cap, the spherical surface section 13 likewise essentially corresponds to a spherical cap section and conforms to the shape of the bulb area underlying the coating.

Due to the reflector means 12, light emitted in its direction is reflected, as indicated by the dotted line P, so that with respect to the light emitting diodes 7 a shadow is produced behind the reflector means 12, whereas the reflected light reinforces the light intensity outside of the shadow. The light is therefore emitted with increased intensity in the left-hand side shown in FIG. 2, as denoted by the angular area W2. Moreover, since the reflector means 12 is not intersected by the longitudinal axis L and is thus less than hemispherical, light is partially emitted forwards and also at a small angle towards the right.

In order to simply set an angle-dependent orientation of the light emission of the lamp 1, for example by screwing the base 4 into a socket, the bulb 3 being connected to the heatsink 5 is for example set by being rotated about the longitudinal axis L. After being screwed into the socket, the bulb 3 together with the reflector means 12 can therefore be rotated until the desired orientation is obtained.

FIG. 3 shows a lamp 20 similar to the lamp 1 in FIG. 1, as well as a reflector means 14 attached thereto in the form of a clip-on reflector element.

The lamp 20 differs from the conventional lamp 1 inasmuch as at its outer face the bulb 3 does not adjoin the heatsink 5 in a flush manner, but at the impact line or contact line the heatsink 5 projects at least partially, for example with its cooling fins 9, laterally over the edge of the bulb 3. As a result, a recess 15 (which can also be described as a gap, slot or a notch) is produced between the bulb 3 and the heatsink 5.

As FIG. 4 shows, the reflector means 14 can be laterally clipped onto or snapped onto the lamp 20, so that the bulb 3 is covered externally in a side area by the reflector means 14. The reflector means 14 has a cap-shaped or dish-shaped reflector part 16 whose inner face 17, which is oriented towards the bulb 3, is made reflecting and constructed so as to essentially conform to the covered area of the bulb 3. At its lower edge the reflector means 14 has two horizontally projecting clamp-type projections 18 which can be engaged with the recess 15 and which partially encircle the lamp 20. Due to the clamp-type projections 18, the reflector means 14 can be pushed, snapped or clipped onto the lamp 20. In this case the reflector means 14 can be rotated about the longitudinal axis L, it being possible for only the bulb 3 itself to be made non-rotatable. Therefore a direction of the light emission of the lamp 20 can likewise be set in a light fixture by rotation of the reflector means 14 around the conventional lamp 20.

However, the reflector means 14 can also be configured so that it can be attached to the conventional lamp 1 in a rotatable manner, in particular by pushing it on.

FIG. 5 shows a side view of a lamp 21 with a reflector means 22, for example a reflecting layer applied to the bulb 3 or in the form of a snap-on or clip-on reflector element, it being possible for the reflector means 22 to now essentially cover exactly one lateral half of the bulb 3. FIG. 6 shows a plan view of the lamp 21.

The reflector means 22 therefore represents a half-space reflector. In this case, due to the reflector means 22, the light emitted by the light emitting diodes 7 is essentially beamed into the left-hand half-space, it being possible, with a deviation of the light emitting diode(s) 7 from the position of the longitudinal axis L, for a small portion of the light to be emitted even slightly obliquely forwards into the right-hand half-space.

FIG. 7 shows a side view of a lamp 31 similar to the lamp 21 shown in FIG. 5, and FIG. 8 shows a plan view of the lamp 31. In this exemplary embodiment a reflector means 32 is configured so that it covers in a reflecting manner an angular sector with respect to the longitudinal axis L of the bulb 3. One edge 33 of the reflector means 14 or of the area of the bulb 3 covered by it, can be defined by two intersecting planes S2 and S3, both of which lie coplanar to the longitudinal axis L and displaced at an angle from one another, it being possible for a line of intersection of the two intersecting planes to lie on the longitudinal axis L.

Naturally, the present invention is not restricted to the illustrated exemplary embodiments.

Other forms of reflector means are therefore also conceivable, for example with a differently formed edge or for example drawn out at the tip over the longitudinal axis L. In this respect it is particularly important that, due to the reflector means, the preferred light emission is in one or more angular areas.

The invention is not restricted to exclusive use with lamps with screw bases, but can include lamps with other types of bases.

Also, the invention is not restricted to use with light emitting diodes, but can also include other light sources, for example miniature fluorescent tubes or other types of semiconductor components, for example laser diodes.

Furthermore, the use of the invention is not restricted to retrofit filament lamp replacements, but can also include other retrofit lamps, for example retrofit halogen lamps or retrofit linear lamps. The invention is also applicable in conjunction with other forms of lamps, it being possible that these other forms of lamps do not correspond to any other retrofit lamp.

In general, the invention is not restricted to the shape or the construction of the lamp described in the exemplary embodiments, and therefore it is not necessary for the bulb to be mounted on a heatsink. Rather, another type of housing part can be used instead of a heatsink.

Moreover, the shape of the bulb is not restricted to a spherical cap, but can be realized in the form of a cylinder or meander-shaped tube, etc.

Furthermore, it is not necessary for the lighting means to be in the form of a push-on or snap-on reflector element located in the mounted state in the vicinity of the bulb. Depending on the angular position, this reflector element with a rotatable attachment on a lamp fitted with a meander-shaped fluorescent tube, can therefore be located at a significant distance from the bulb (such as this fluorescent tube). In particular, the term bulb is therefore understood to be a general bulb which shields the lighting means (light emitting diodes, fluorescent gas, etc.) against the surroundings of the lamp.

The lamp may also be adaptable to the snap-on reflector element.

### LIST OF REFERENCE NUMBERS

1 Lamp
2 Tip
3 Bulb
4 Base
5 Heatsink
6 Front face of heatsink
7 Light emitting diode
8 Circle
9 Cooling fin
11 Lamp
12 Reflector means
13 Spherical surface section
14 Reflector means
15 Recess
16 Cap-shaped reflector part
17 Inner face
18 Clamp
19 Inner space of bulb
20 Lamp
21 Lamp
22 Reflector means
31 Lamp
32 Reflector means
33 Edge
L Longitudinal axis of lamp
P Direction of emitted light
W1 Angular area
S1 Intersecting plane
S2 Intersecting plane
S3 Intersecting plane

1. A lamp, comprising:
at least one light source; and
at least one reflector means for reflecting light that has been emitted by the at least one light source,
wherein the at least one reflector means has a radial asymmetric form about a longitudinal axis of the lamp.

2. The lamp as claimed in claim 1, wherein the at least one reflector means is rotatable about the longitudinal axis.

3. The lamp as claimed in claim 1,
wherein the lamp is a light emitting diode retrofit replacement for an incandescent lamp.

4. The lamp as claimed in claim 1,
wherein the lamp has at least one partially transparent bulb which extends over the at least one light source of the lamp, and the at least one reflector means is arranged on the bulb.

5. The lamp as claimed in claim 4, it being possible for the lamp to have a heatsink on the front face of which is arranged the at least one light source and to the front face of which the bulb is connected.

6. The lamp as claimed in claim 1,
wherein the at least one reflector means is configured in the form of a reflector element which can be snapped onto the lamp and which can be rotated relative to the longitudinal axis.

7. The lamp as claimed in claim 6,
wherein the at least one reflector means encloses one part of the lamp.

8. The lamp as claimed in claim 6,
wherein the reflector means has a clamp for rotatable latching between the heatsink and the bulb.

9. The lamp as claimed in claim 4,
wherein the at least one reflector means is configured as at least one reflecting layer of the bulb.

10. The lamp as claimed in claim 8,
wherein at least one of the bulb and a heatsink is rotatable.

11. The lamp as claimed in claim 1,
wherein the at least one reflector means is configured in the form of a spherical cap and arranged at one side face of the bulb.

12. The lamp as claimed in claim 11,
wherein at least one spherical surface section lies essentially parallel to the longitudinal axis of the lamp.

13. The lamp as claimed in claim 11,
wherein the longitudinal axis does not intersect or touch the reflector means.

14. A reflector element for subsequent fixing to a lamp comprising:
a fixing element for fixing the reflector element to the lamp in a clamping and rotatable manner.

15. The reflector element as claimed in claim 14,
wherein the reflector element is configured to cover a bulb of the lamp in a partially reflecting manner.

16. The lamp as claimed in claim 7,
wherein the at least one reflector means encloses one part of the bulb.

17. The lamp as claimed in claim 7,
wherein the at least one reflector means encloses one part of the lamp to enclose said bulb in a conformal manner.

18. The lamp as claimed in claim 10,
wherein at least one of the bulb and the heatsink is rotatable with respect to a base.

19. The reflector element as claimed in claim 15,
wherein the fixing element comprises a clamp.
